(19) United States
(12) Patent Application Publication
(10) Pub. No.: US 2014/0353541 A1
(43) Pub. Date: Dec. 4, 2014

(54) WORKING FLUID AND MANUFACTURING METHOD OF METAL NANO-PARTICLES

(71) Applicant: National Tsing Hua University, Hsinchu City (TW)

(72) Inventors: Yu-Lun CHUEH, Hsinchu City (TW); Ming-Chang LU, Hsinchu City (TW); Chih-Chung LAI, Hsinchu City (TW); Wen-Chih CHANG, Hsinchu City (TW); Wen-Liang HU, Hsinchu City (TW)

(73) Assignee: National Tsing Hua University, Hsinchu City (TW)

(21) Appl. No.: 14/093,315

(22) Filed: Nov. 29, 2013

(30) Foreign Application Priority Data
May 30, 2013 (TW) 102119196

(51) Int. Cl. C09K 5/10

(52) U.S. Cl. CPC C09K 5/10
USPC 252/71

(57) ABSTRACT

A working fluid in cooperation with a solar thermal system comprises a heat conduction medium and a plurality of metal nano-particles mixed in the heat conduction medium. Each of the metal nano-particles includes a metal particle and a protection layer, and the protection layer is an oxide and covers the metal particle. A manufacturing method of metal nano-particles is also disclosed.

### CROSS REFERENCE TO RELATED APPLICATIONS

This Non-provisional application claims priority under 35 U.S.C. §119(a) on Patent Application No(s). 102119196 filed in Taiwan, Republic of China on May 30, 2013, the entire contents of which are hereby incorporated by reference.

### BACKGROUND OF THE INVENTION

1. Field of Invention

The invention relates to a working fluid and a manufacturing method of nano-particles and, in particular, to a working fluid and a manufacturing method of nano-particles that can be applied to a solar thermal system.

2. Related Art

Highly restricted by the sunrise and sunset, solar energy is just produced in the daytime. A solar thermal energy system can store the thermal energy from sunlight to provide the energy for both daytime and the nighttime usage, and thus becomes a promising field of the new energy resource. The operating principle of the solar thermal system is illustrated as below. A working fluid stored within a container is heated by the sunlight reflected by a solar tracking apparatus. The heating working fluid then flows to a heat exchanger that transporting its heat to produce water streams to propel a turbo-generator for generating required electric power. Meanwhile, the cooled working fluid after the heat exchange will flow back to the container, finishing a complete cycle.

The heat storing capability of the solar thermal system mainly depends on the heat capacity of the working fluid. However, the effective heat capacity of the current solar thermal system is relatively less (less than the liquid water), led to a less heat storing capability of the solar thermal system, thus limiting the application and development of the solar thermal systems.

### SUMMARY OF THE INVENTION

An objective of the invention is to provide a working fluid with higher heat capacity to enhance the heat storage of the solar thermal system for possible future real practical application thereof.

Besides, another objective of the invention is to provide a manufacturing method of metal nano-particles that has several advantages such as simplified processes, lower cost and multiple applications, and the nano-particles can be added into the working fluid to effectively enhance the heat capacity thereof.

To achieve the above objective, a working fluid according to the invention is in cooperation with a solar thermal system and comprises a heat conduction medium and a plurality of metal nano-particles mixed in the heat conduction medium. Each of the metal nano-particles includes a metal particle and a protection layer, and the protection layer is an oxide that covers the surface of metal particles.

To achieve the above objective, a manufacturing method of metal nano-particles according to the invention comprises steps of: adding a metal particle into an alcoholic solvent to form a first solution, wherein the metal particle includes a metal nano-particle or an alloy nano-particle; heating the first solution and adding a precursor to the first solution to form a second solution; adjusting the pH value of the second solution to between 4 and 5; and implementing an annealing procedure to form a protection layer on the surface of the metal particle, wherein the protection layer is an oxide covering the metal particle.

In one embodiment, the metal particle includes a pure metal or an alloy that absorbs heat at a working temperature.

In one embodiment, the weight percent of the metal nano-particles added to the heat conduction medium ranges between 1% and 10%.

In one embodiment, the oxide includes a metal oxide or SiOₓ.

In one embodiment, the metal nano-particles are reusable.

In one embodiment, the precursor includes 3-Aminopropyl trimethoxysilane (APTMS), γ-Glycidoxypropyltrimethoxysilane (GPTMS), or tetraethyl orthosilicate (TEOS).

In one embodiment, the annealing temperature of the annealing procedure ranges between 200° C. and 300° C., and the annealing duration ranges between one hour and two hours.

As mentioned above, the manufacturing method of the metal nano-particles includes the steps of adding a metal particle to an alcoholic solvent to form a first solution, wherein the metal particle includes a metal nano-particle or an alloy nano-particle; heating the first solution and adding a precursor to the first solution to form a second solution; adjusting the pH value of the second solution to between 4 and 5; and implementing an annealing procedure to form a protection layer on the surface of the metal particle, wherein the protection layer is an oxide covering the metal particle. Thereby, the manufacturing method of metal nano-particles of the invention can have several advantages such as simplified processes, lower cost and multiple applications. Since invention of the metal nano-particles is highly able to convey heat and store heat, they are suitable to be added to the heat conduction medium of a solar thermal system, not verifying its' flow resistance, for increasing the effective heat capacity of the working fluid. Besides, the working fluid including the metal nano-particles of the invention can be applied to the solar thermal system. The working fluid includes a heat conduction medium and a plurality of metal nano-particles mixed in the heat conduction medium. Each of the metal nano-particles includes a metal particle and a protection layer, which is an oxide that fully covers the surface of metal particles. Thereby, the working fluid of the invention can have a higher effective heat capacity to increase the heat storing capability of the solar thermal system for possible future real practical application thereof.

### BRIEF DESCRIPTION OF THE DRAWINGS

The invention will become more fully understood from the detailed description and accompanying drawings, which are given for illustration only, and thus are not limitative of the present invention, and wherein:

FIG. 1 is a flow chart of a manufacturing method of nano-particles according to a preferred embodiment of the invention;

FIG. 2 is a schematic diagram of a solar thermal system;

FIG. 3A is an SEM micrograph of the metal particles according to the invention;

FIG. 3B is a TEM micrograph of the metal particles in FIG. 3A;

FIG. 3C is an SEM micrograph of the metal nano-particles according to the invention;

FIG. 3D is a TEM micrograph of the metal nano-particles in FIG. 3C;

FIG. 4A is a schematic diagram showing the X-ray diffraction of the tin nano-particles experiencing the heat treatment of different annealing temperatures;

FIGS. 4B and 4C are schematic diagrams showing the real-time X-ray diffraction of the metal nano-particles of the invention;

FIG. 5A is a schematic diagram showing the change of the latent heat of the metal nano-particles and tin nano-particles with different number of times of the circulation;

FIG. 5B is a schematic diagram showing the change of the heat flow of the metal nano-particles and tin nano-particles with different number of times of the circulation;

FIG. 6A is an SEM micrograph of the Hitec molten salt;

FIG. 6B is an SEM micrograph of the Hitec molten salt with the metal nano-particles therein;

FIG. 6C is a schematic diagram showing the effective heat capacities of the Hitec molten salt including 1 wt %, 3 wt % and 5 wt % metal nano-particles respectively;

FIGS. 6D and 6E are schematic diagrams respectively showing the changes of the heat capacity of the Hitec molten salt including 3 wt % and 5 wt % metal nano-particles with different number of times of the circulation; and

FIG. 7 is a schematic diagram showing the change of the heat capacity of the Hitec molten salt including the metal oxide nano-particles therein.

### DETAILED DESCRIPTION OF THE INVENTION

The present invention will be apparent from the following detailed description, which proceeds with reference to the accompanying drawings, wherein the same references relate to the same elements.

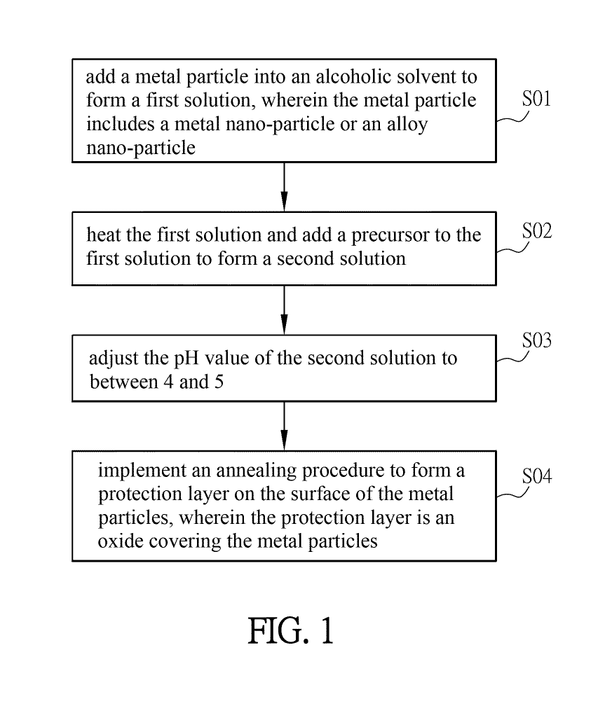

FIG. 1 is a flow chart of a manufacturing method of nano-particles according to a preferred embodiment of the invention. The manufacturing method of nano-particles includes the steps S01 to S04.

First, the step S01 is to add a metal particle into an alcoholic solvent to form a first solution, wherein the metal particle includes a metal nano-particle or an alloy nano-particle. The said metal can include tin or aluminum and the said alloy can include aluminum-germanium alloy, for example. The metal or alloy can be other kinds as long as they can absorb the heat at the working temperature (such as a temperature range marked on the molten salt products, and here of 142° C.-535° C. as an example) of a working fluid. Herein, the metal particle is a tin nano-particle and the alcoholic solvent is ethanol, for example. Accordingly, the tin nano-particle is added into the ethanol to form the first solution of 0.05M. However, in other embodiments, other kinds of metal particle or alcoholic solvent can be joined, and thus the concentration of the first solution has a range of 0.01M˜0.1M.

The step S02 is to heat the first solution and add a precursor to the first solution to form a second solution. Herein, the first solution is heated to about 80° C. The precursor can include 3-Aminopropyl trimethoxysilane (APTMS), γ-Glycidoxypropyltrimethoxysilane (GPTMS), or tetraethyl orthosilicate (TEOS) for example. In this embodiment, a small amount (e.g. between 50 μl and 500 μl) of APTMS, 99.999% purity, is added to the first solution to form the second solution. However, in other embodiments, other kinds of precursors can be used. In the invention, APTMS is given as an example, and it can be directly bonded to the tin nano-particles (amino group of APTMS can be directly bonded to the tin nano-particles) without bonding the functional group of modification to the surface of the tin nano-particles first. Therefore, the manufacturing process of the invention can be simplified with the lower cost.

The step S03 is to adjust the pH value of the second solution to between 4 and 5. Thereby, the precursor can be uniformly attached to the tin nano-particles. The adjustment of the pH value can be accompanied by a sufficient stirring, and thus the nano-particles can be uniformly distributed in the solution.

The step S04 is to implement an annealing procedure to form a protection layer on the surface of the metal particles, wherein the protection layer is an oxide that covers the surface of metal particles. Herein, the annealing temperature of the annealing procedure can range between 200° C. and 300° C., and the annealing duration can range between one hour and two hours. The alcoholic solvent is evaporated during the heating process, and then the extra precursors and water are removed during the annealing procedure. Afterward, the protection layer can be formed to enclose the metal particles, and the metal particles with the protection layer become the metal core-shell nano-particles. The protection layer can include, for example, metal oxide or SiOₓ. In this embodiment, a SiOₓ protection layer can be formed on the surface of the tin nano-particle by the annealing procedure, and thereby the metal nano-particles of tin-SiOₓ core-shell can be produced.

The manufacturing method of the metal nano-particles of the invention is similar to a sol-gel method, which involves a conversion process from a liquid phase (sol) to a solid phase (gel) and has advantages such as simple processes and lower cost. Besides, because the protection layer encloses the metal particles, the oxidation of the metal particles can be prevented in the high-temperature environment, and therefore the nano-particles can keep it as original form. In addition to the tin nano-particles, the manufacturing method of the invention can be also applied to other kinds of metal or alloy nano-particles, achieving multiple applications. Moreover, the produced metal nano-particles can be added into a heat conduction medium to form a nano fluid, which is also called a working fluid. Since the metal nano-particles are highly able to convey heat and store heat and will not become an flow resistance, they are suitable to be added to the heat conduction medium of a solar thermal system.

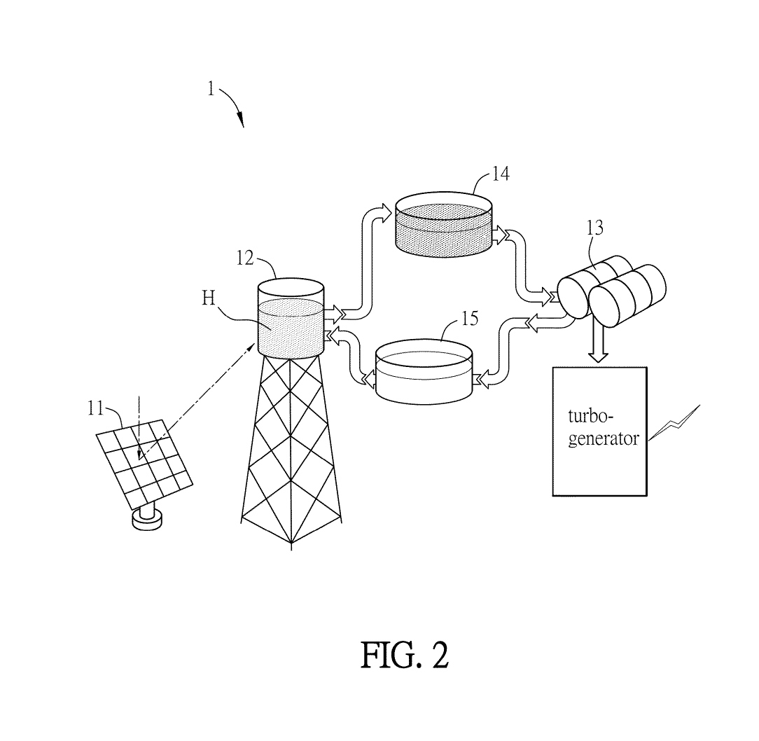

FIG. 2 is a schematic diagram of a solar thermal system 1. Herein, the operating principle of the solar thermal system 1 will be first and the working fluid of the invention will be second illustrated.

The solar thermal system 1 includes a light reflecting apparatus 11, a receiving apparatus 12 and a heat exchanging apparatus 13. The solar thermal system 1 further includes two storing apparatuses 14, 15. The heat conduction medium H can cyclically flows through the receiving apparatus 12, the storing apparatuses 14 and 15, and the heat exchanging apparatus 13. The light reflecting apparatus 11 can include a solar tracking system and reflect the sunlight to the receiving apparatus 12 for heating the heat conduction medium H within the receiving apparatus 12. The heated heat conduction medium H is stored by the storing apparatus 14 and then transferred to the heat exchanging apparatus 13 that can transfer heat of the heat conduction medium H to the water that heating the water to steam. The steam can propel the turbo-generator to generate the required electric power. Meanwhile, the cooled heat conduction medium H after the heat exchange is transferred to the storing apparatus 15 and then the receiving apparatus 12, thus a complete cycle is operated. Accordingly, the heat conduction medium H is used to store the heat of the sunlight, and the power is generated by the heat exchange and the turbo-generator. Although the heat conduction medium H in the solar thermal system 1 is used to store heat by its sensible heat, the fact is that the latent heat of the substance is larger than the sensible heat. So, if the latent heat can be used to store heat, the heat storing capability of the solar thermal system 1 can be apparently greater than that of just using the sensible heat. Theoretically speaking, the said metal nano-particles are added into the heat conduction medium H in this invention to enhance the total heat capacity of the solar thermal system 1. That is, the latent heat of the metal nano-particles is used to increase the heat storing capability of the solar thermal system 1, which expanded the application of the solar thermal system 1.

The working fluid of the invention is in cooperation with the solar thermal system 1. The working fluid is a phase-change fluid-like heat transfer materials and can be reused several times within the loop of the solar thermal system 1. In the invention, a plurality of metal nano-particles are added into the heat conduction medium H to form a working fluid of the solar thermal system 1. The weight percent of the metal nano-particles added to the heat conduction medium H can range between 1% and 10%. Accordingly, the metal nano-particles are mixed in the heat conduction medium H to increase the heat capacity thereof and can be reused. Each the metal nano-particle includes a metal particle and a protection layer. The protection layer is an oxide and encloses the metal particle. Since the manufacturing method and other features of the metal nano-particles are clearly illustrated in the above embodiments, they are not described here for conciseness.

The heat conduction medium H of the solar thermal system 1 can be a homogeneous fluid with a stable heat capacity within a certain temperature range (e.g. 100° C.-500° C. or more), and the material thereof could be inorganic salt or organic polymer. The said inorganic salt can be molten salt formed by several inorganic compound mixed together, nitrate, phosphate, or halide, for example. The said nitrate includes NaNO₃, KNO₃ or NaNO₂ for example. The heat conduction medium H of this embodiment is eutectic salt (called Hitec molten salt hereinafter) as an example, composed of 7% sodium nitrate, 53% potassium nitrate and 40% sodium nitrite. Otherwise, the heat conduction medium H can have other compositions and weight percents.

Then, other technical features of the metal nano-particles and working fluid will be illustrated as below by referring to the related figures.

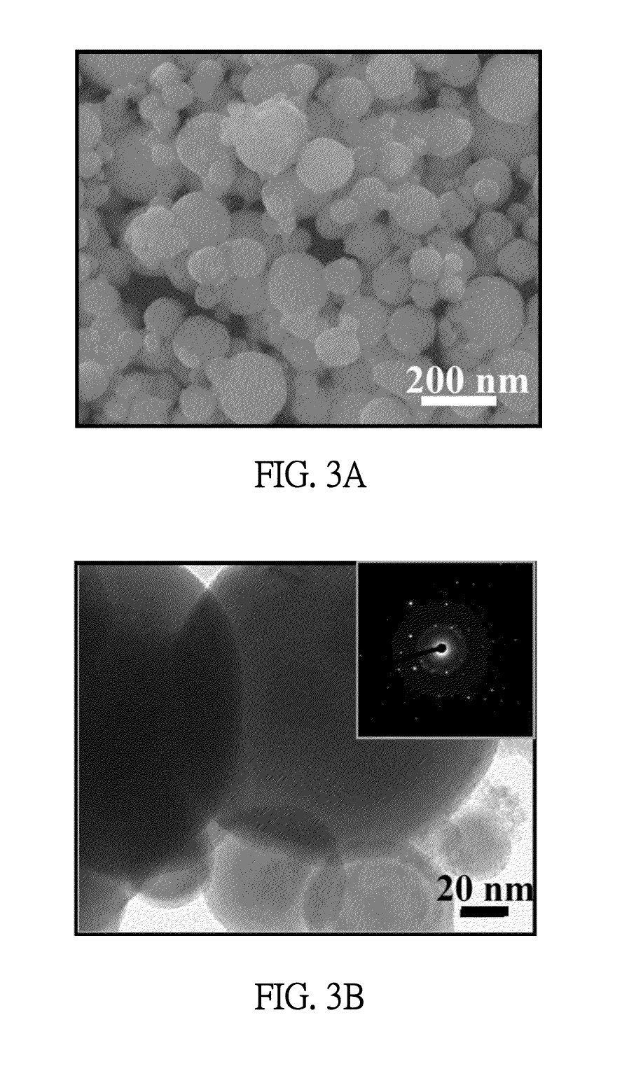

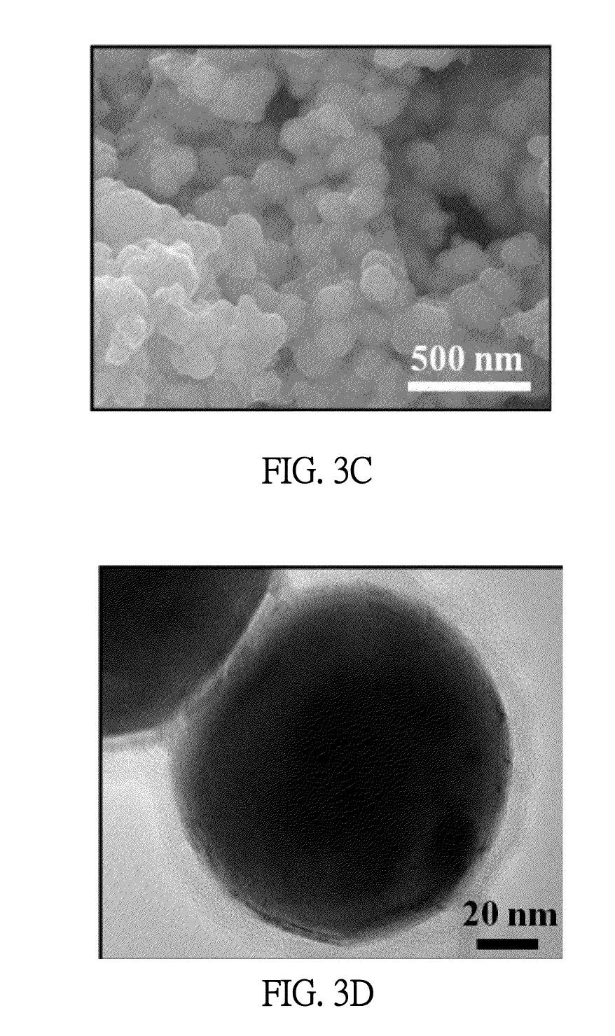

FIG. 3A is an SEM micrograph of the metal particles (tin nano-particles) according to the invention, FIG. 3B is a TEM micrograph of the metal particles in FIG. 3A, FIG. 3C is an SEM micrograph of the metal nano-particles according to the invention, and FIG. 3D is a TEM micrograph of the metal nano-particles in FIG. 3C.

It can be seen from the TEM micrograph of FIG. 3B that the tin nano-particle is a poly-crystalline type. Besides, it can be seen from FIGS. 3C and 3D that the protection layer (SiOₓ) certainly encloses the tin nano-particle of the metal nano-particle made by the manufacturing method of the metal nano-particles of the invention, where the diameter of the metal nano-particle is about 100 nm and the thickness of the protection layer is about 5˜10 nm.

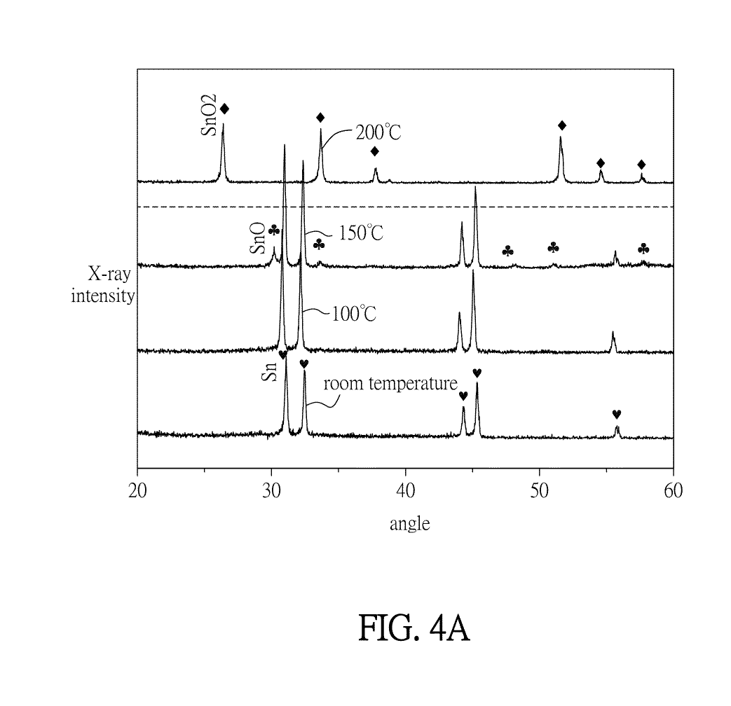

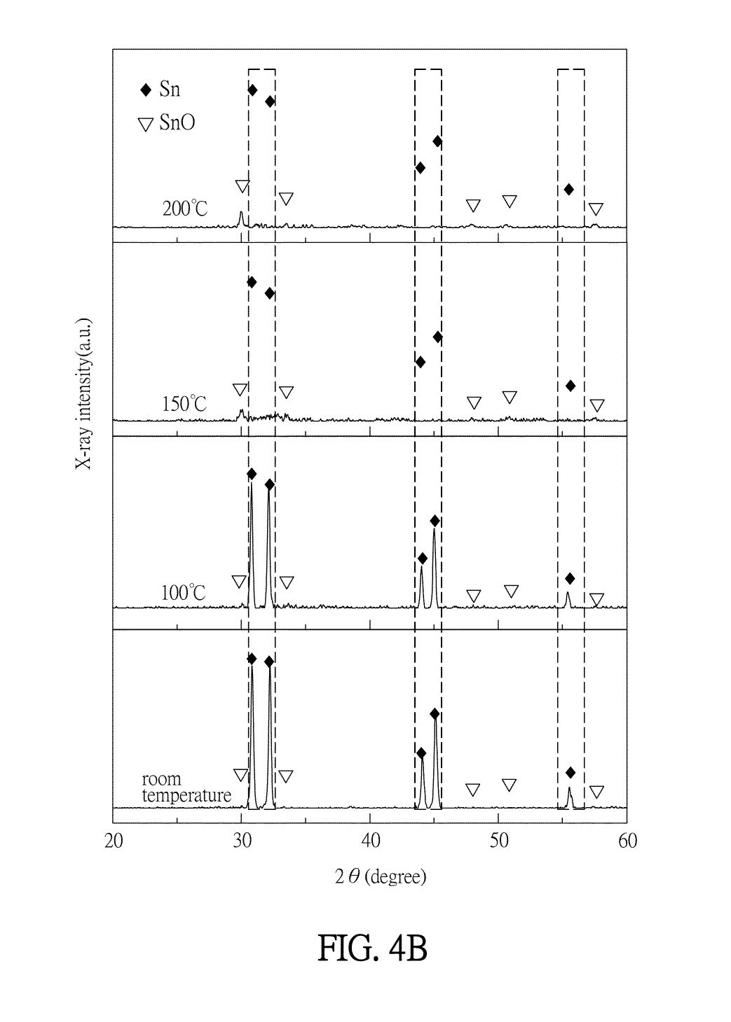

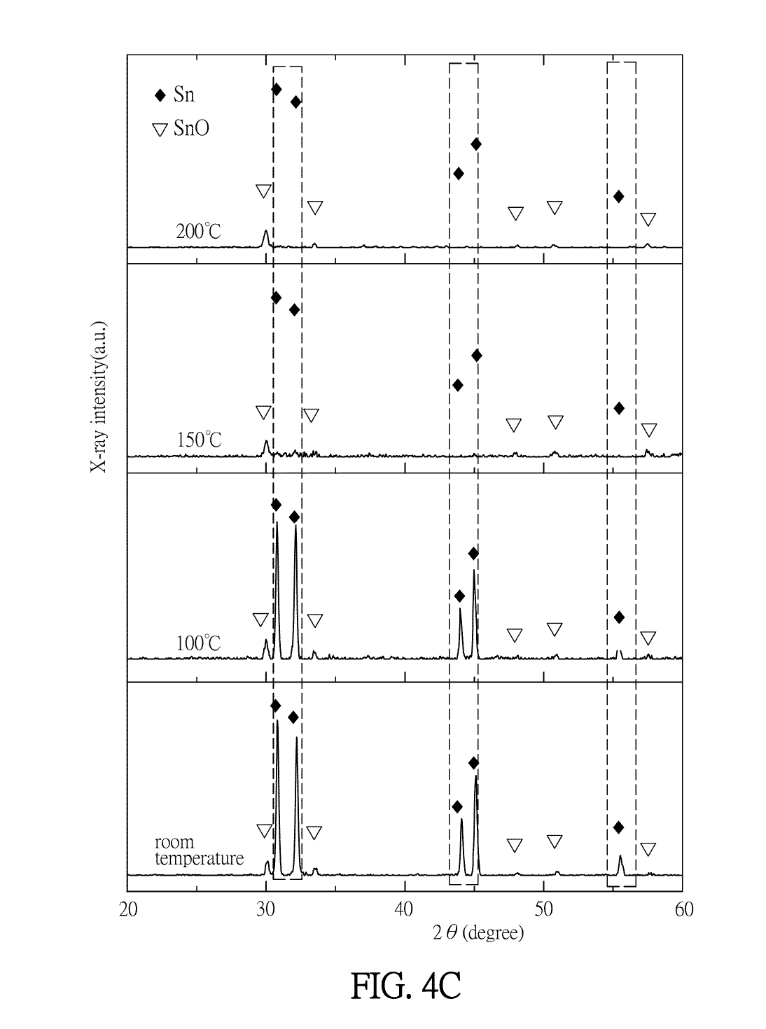

FIG. 4A is a schematic diagram showing the X-ray diffraction of the tin nano-particles experiencing the heat treatment of different annealing temperatures.

In FIG. 4A, after the heat treatment of 200° C., the pure tin nano-particle almost becomes a complete crystalline phase of tin oxide. That is, the spectrum of the said particle is totally different from that of the room-temperature tin nano-particle and that of the metal nano-particles made by the annealing temperatures of 100° C. and 150° C. respectively. It indicates that the heat treatment apparently influences the metal content of the pure tin nano-particles.

FIGS. 4B and 4C are schematic diagrams showing the real-time X-ray diffraction of the metal nano-particles of the invention. FIG. 4B is the X-ray diffraction diagram from the room temperature up to 200° C., and FIG. 4C is the X-ray diffraction diagram from 200° C. down to the room temperature. Moreover, the solid rhombus in the figure denotes the signal of Sn while the hollow inverted triangle denotes the signal of SnO.

It can be seen from FIG. 4B that the signal of Sn weakens more with the temperature climbing more, and there is no signal of Sn, meaning the tin has been completely molten, at 150° C. or more. Besides, seen from FIG. 4C, the signal of Sn strengthens more when the temperature is decreased from 200° C. to the room temperature, and the signal of Sn appears again at 100° C. or less, meaning the tin has been solidified at 100° C. or less. From the above results, it can be proofed that the Sn—SiOₓ nano-particles have been successfully synthesized in the invention and the SiOₓ protection layer successfully protects the molten tin.

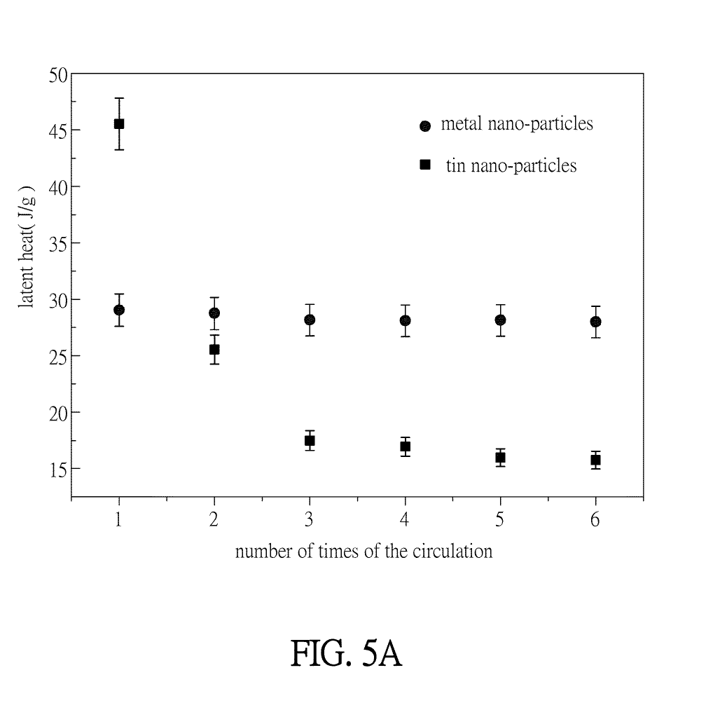

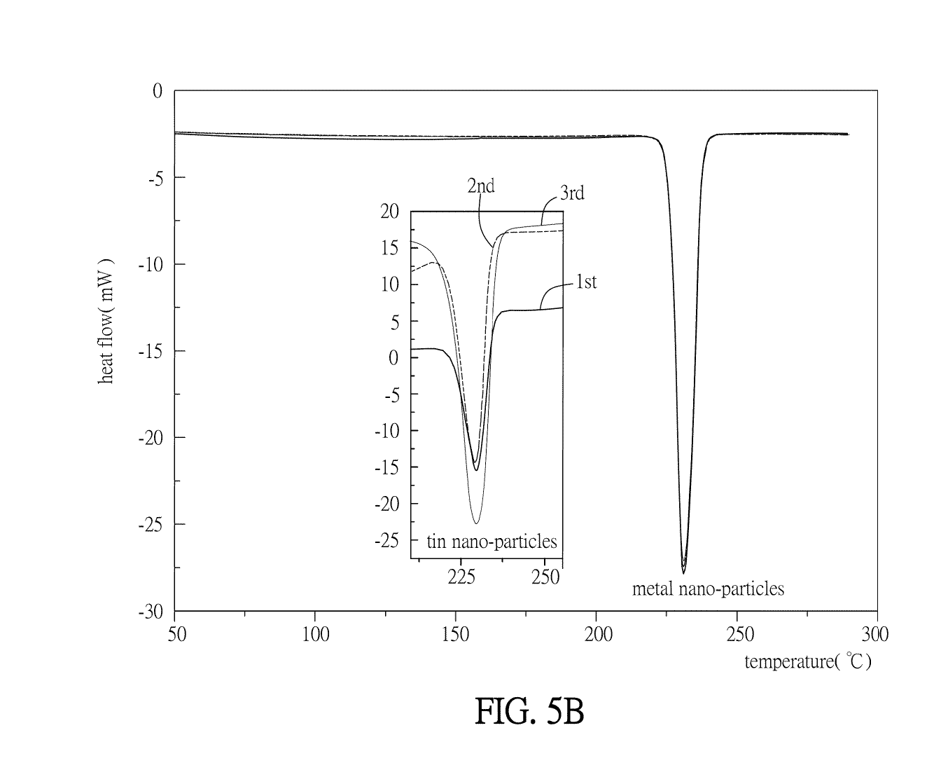

FIG. 5A is a schematic diagram showing the change of the latent heat of the metal nano-particles and tin nano-particles with different number of times of the circulation, and FIG. 5B is a schematic diagram showing the change of the heat flow of the metal nano-particles and tin nano-particles with different number of times of the circulation.

It can be found in FIG. 5A that the latent heat of the metal nano-particles is still very stable (about 28.16 J/g) after several times of the circulation. However, when the tin nano-particles without the protection layer are joined, the latent heat fluctuates a lot and seems unstable with different number of times of the circulation. Besides, it can be found in FIG. 5B that the curves of the heat flow of the metal nano-particles with different number of times of the circulation still overlap and seem relatively stable whereas the heat flow of the tin nano-particles seems unstable and fluctuates a lot. Therefore, in the invention, the metal nano-particles still can keep the features and properties thereof very stable even though they are used several times. Accordingly, the metal nano-particles of the invention are favorably suitable to be added into the heat conduction medium H of the solar thermal system 1 to form the working fluid thereof.

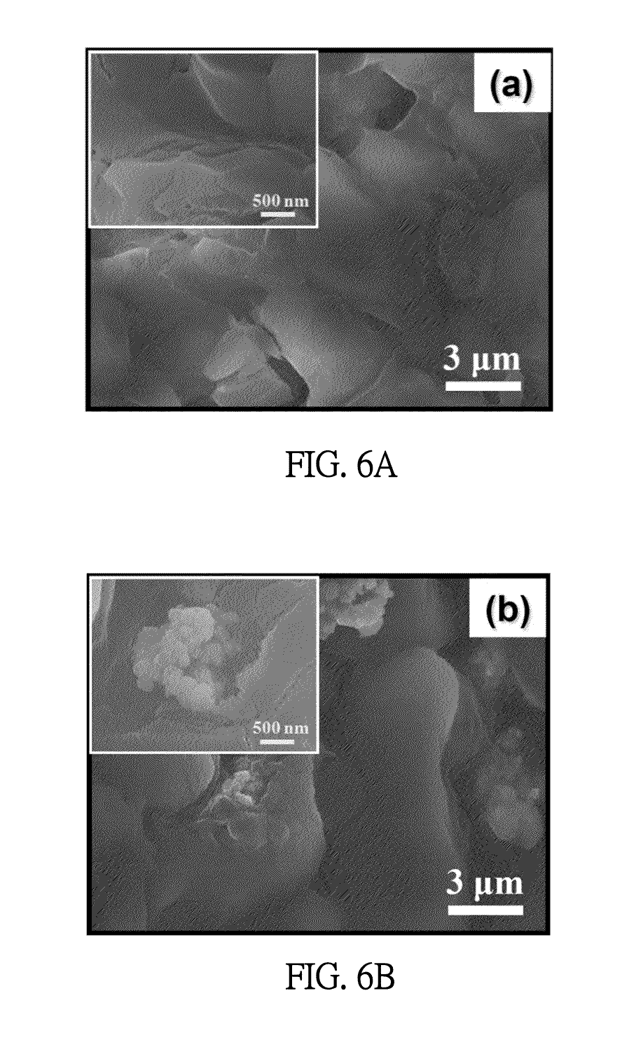

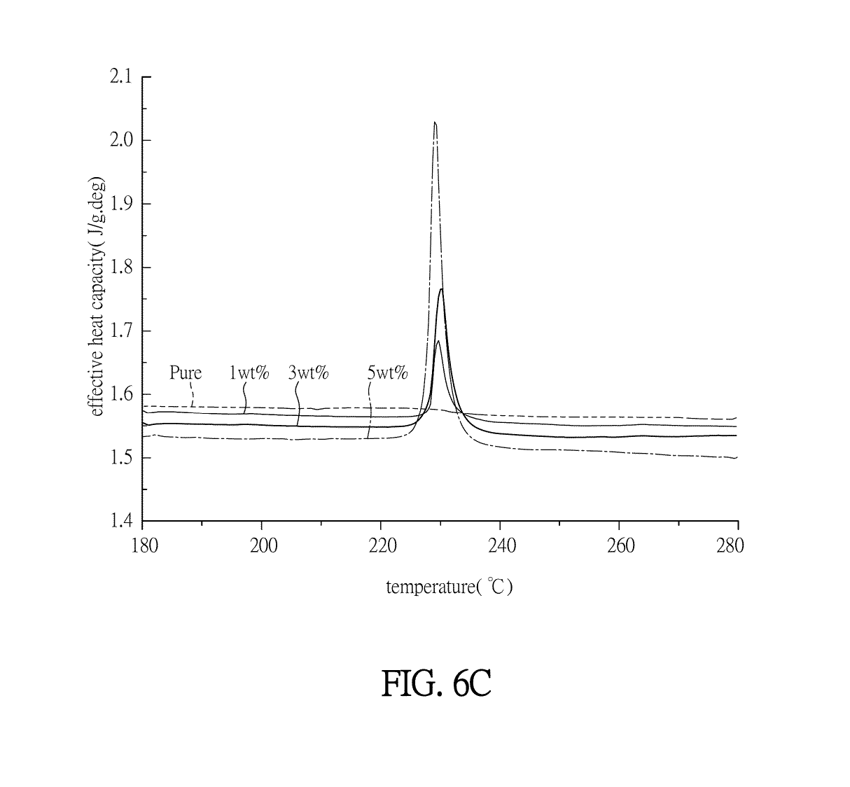

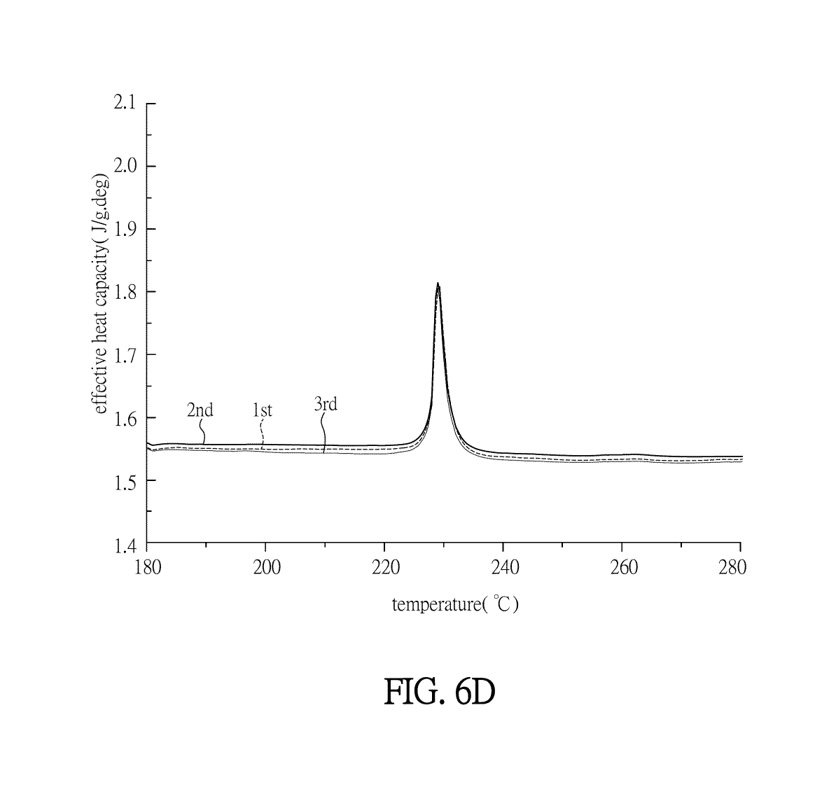

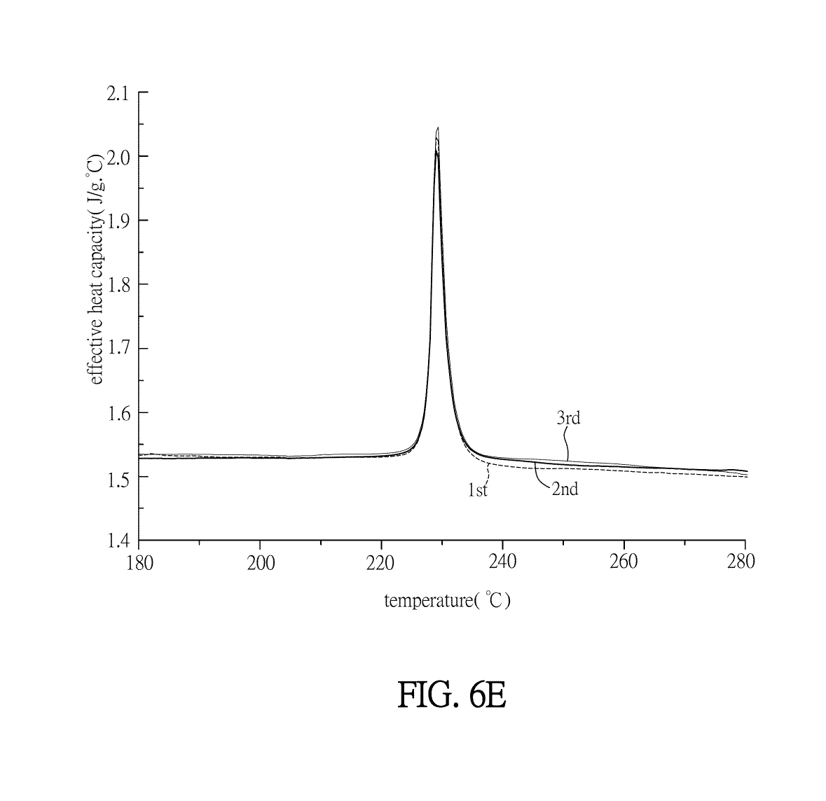

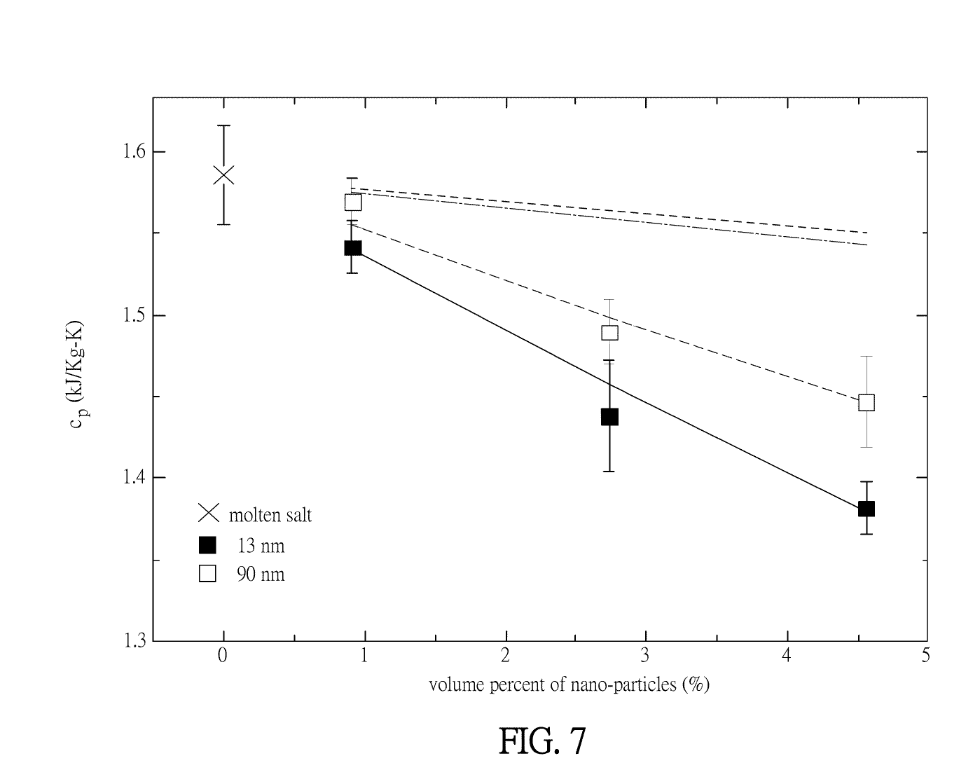

FIG. 6A is an SEM micrograph of the Hitec molten salt, and FIG. 6B is an SEM micrograph of the Hitec molten salt with the metal nano-particles therein. The enlarged diagram at the upper left corner of FIG. 6B shows that the metal nano-particles are distributed in the Hitec molten salt.

FIG. 6C is a schematic diagram showing the effective heat capacities of the Hitec molten salt including 1 wt %, 3 wt % and 5 wt % metal nano-particles respectively, and FIGS. 6D and 6E are schematic diagrams respectively showing the changes of the heat capacity of the Hitec molten salt including 3 wt % and 5 wt % metal nano-particles with different number of times of the circulation.

As shown in FIG. 6C, even though the metal nano-particles of different weight percents are individually added to the Hitec molten salt, the effective heat capacities of the working fluids all sharply ascend in the vicinity of the melting point of tin (225° C., i.e the above-mentioned working temperature), caused by the release of the latent heat of the working fluid. When the 1 wt % metal nano-particles are added to the Hitec molten salt, the effective heat capacity of the working fluid in the vicinity of the melting point of tin is increased by 6.4% ((1.67-1.57)/1.57*100%=6.4%). When the 3 wt % metal nano-particles are added to the Hitec molten salt, the effective heat capacity of the working fluid in the vicinity of the melting point of tin is increased by 12.7% ((1.77-1.57)/1.57*100%=12.7%). When the 5 wt % metal nano-particles are added to the Hitec molten salt, the effective heat capacity of the working fluid in the vicinity of the melting point of tin is increased by 29.3% ((2.03-1.57)/1.57*100%=29.3%).

As shown in FIGS. 6D and 6E, in the cases of the metal nano-particles of 3 wt % and 5 wt % individually added into the Hitec molten salt, the working fluids still have very stable heat capacities in the vicinity of the melting point of tin despite different number of times of the circulation. Accordingly, it is proofed again that the metal nano-particles and working fluid of the invention can have very stable effective heat capacity and thus are suitable for the application of the solar thermal system 1 with the circulating use.

To be noted, the metal nano-particle includes a metal particle and a protection layer. The material of the protection layer includes an oxide (e.g. including metal oxide or SiOₓ) covering the metal particle. According to the technical literatures, technical personnel added the Al₂O₃ nano-particles to the Hitec molten salt before. However, by referring to the technical literatures such as FIG. 7, it can be found that the heat capacity (Cp) is less when the Al₂O₃ nano-particles of a higher volume percent are joined, resulting in a bad effect. Therefore, the metal oxide nano-particles without the protection layer are unsuitable to be added to the Hitec molten salt of the solar thermal system 1.

In summary, the manufacturing method of the metal nano-particles includes the steps of: adding a metal particle to an alcoholic solvent to form a first solution, wherein the metal particle includes a metal nano-particle or an alloy nano-particle; heating the first solution and adding a precursor to the first solution to form a second solution; adjusting the pH value of the second solution to between 4 and 5; and implementing an annealing procedure to form a protection layer on the surface of the metal particle, wherein the protection layer is an oxide covering the metal particle. Thereby, the manufacturing method of metal nano-particles of the invention can have several advantages such as simplified processes, lower cost and multiple applications. Since the metal nano-particles of the invention are highly able to convey heat and store heat and will not be a flow resistance, they are suitable to be added to the heat conduction medium of a solar thermal system for increasing the effective heat capacity of the working fluid. Besides, the working fluid including the metal nano-particles of the invention can be applied to the solar thermal system. The working fluid includes a heat conduction medium and a plurality of metal nano-particles mixed in the heat conduction medium. Each of the metal nano-particles includes a metal particle and a protection layer, which is an oxide and covers the metal particle. Thereby, the working fluid of the invention can have a higher effective heat capacity to increase the heat storing capability of the solar thermal system and expand the application thereof.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A working fluid in cooperation with a solar thermal system, comprising:
a heat conduction medium; and
a plurality of metal nano-particles mixed in the heat conduction medium, wherein each of the metal nano-particles includes a metal particle and a protection layer, and the protection layer is an oxide and covers the metal particle.

2. The working fluid as recited in claim 1, wherein the metal particle includes a pure metal or an alloy that absorbs heat at a working temperature.

3. The working fluid as recited in claim 1, wherein the weight percent of the metal nano-particles added to the heat conduction medium ranges between 1% and 10%.

4. The working fluid as recited in claim 1, wherein the oxide includes a metal oxide or SiOₓ.

5. The working fluid as recited in claim 1, wherein the metal nano-particles are reusable.

6. A manufacturing method of metal nano-particles, comprising steps of:
adding a metal particle into an alcoholic solvent to form a first solution, wherein the metal particle includes a metal nano-particle or an alloy nano-particle;
heating the first solution and adding a precursor to the first solution to form a second solution;
adjusting the pH value of the second solution to between 4 and 5; and
implementing an annealing procedure to form a protection layer on the surface of the metal particle, wherein the protection layer is an oxide covering the metal particle.

7. The manufacturing method as recited in claim 6, wherein the metal particle includes a pure metal or an alloy that absorbs heat at a working temperature.

8. The manufacturing method as recited in claim 6, wherein the precursor includes 3-Aminopropyl trimethoxysilane (APTMS), γ-Glycidoxypropyltrimethoxysilane (GPTMS), or tetraethyl orthosilicate (TEOS).

9. The manufacturing method as recited in claim 6, wherein the annealing temperature of the annealing procedure ranges between 200° C. and 300° C., and the annealing duration ranges between one hour and two hours.

10. The manufacturing method as recited in claim 6, wherein the oxide includes a metal oxide or SiOₓ.
